(19) United States
(12) Patent Application Publication
(10) Pub. No.: US 2006/0275616 A1
(43) Pub. Date: Dec. 7, 2006

(54) Silane-based coupling agent

(76) Inventors: Robert S. Clough, St. Paul, MN (US); Shichun Qu, Woodbury, MN (US); Guoping Mao, Woodbury, MN (US)

Correspondence Address: 3M INNOVATIVE PROPERTIES COMPANY, PO BOX 33427, ST. PAUL, MN, 55133-3427, US

(21) Appl. No.: 11/144,456

(22) Filed: Jun. 3, 2005

(51) Int. Cl. B32B 9/04; B32B 27/32

(52) U.S. Cl. 428/448; 428/523

(57) ABSTRACT

An article having a benzocyclobutene-based resin layer and a coupling agent containing a mixture of a vinylsilane and an aminosilane.

### TECHNICAL FIELD

This invention relates to surface-treatment of an inorganic layer with a silane-based coupling agent.

### BACKGROUND

Polymers are extensively used in electronic packaging. Electronic packages are multilayered structures, whose reliability is strongly influenced by the interfacial adhesion and resistance to debonding of the polymer/inorganic interfaces. Integrity of the interfaces in sometimes demanding environments is considered fundamental for acceptable performance of the package. Benzocyclobutenes (BCB's) are a promising class of polymeric materials due to their low dielectric constant, low dielectric loss tangent or dissipation factor, high glass transition temperature, and low moisture uptake. While the hydrophobic nature of these materials helps to impart the excellent dielectric properties and moisture resistance, it can provide for poor adhesion to other substrates such as metals, including their oxides, chromate layers, and ceramics often employed in electronic and microelectronic packaging.

### SUMMARY

Thus, there is a need for an improved primer for increasing the adhesion of BCB to inorganic substrates such as metals, metal oxides, chromates, ceramics, and the like.

One aspect of the invention features an article comprising:

an inorganic layer,

a silane coupling agent layer on the inorganic layer, the silane coupling agent layer formed from a mixture comprising a vinylsilane and an aminosilane, and

a benzocyclobutene-based resin on the silane coupling agent layer, wherein the vinylsilane has the following formula:
(R₁)ₐSi(R₂)_{b}(X)_{4-a-b}
where each R₁ is independently an alkenyl or alkynyl group having no more than 3 covalent bonds separating the carbon-carbon double or triple bond and the silicon atom; each R₂ is independently an alkyl or aryl group having from 1 to about 8 carbons; each X is independently an alkoxy group having from 1 to about 8 carbon atoms; a is 1, 2, or 3; b is 0, 1, or 2; and a+b is greater than or equal to 1 and less than or equal to 3.

Other features and advantages of the invention will be apparent from the following drawings, detailed description, and claims.

### DETAILED DESCRIPTION

At least one aspect of the invention involves using a silane-based coupling agent composition for inorganic substrates to provide superior adhesion between the substrates and benzocyclobutene (BCB)-based resins, i.e., resins containing benzocyclobutenes.

BCB-based resins are of interest in electronic applications principally as electrical insulating materials due to their low dielectric constant, low dielectric loss, high glass transition temperature, and low moisture absorption. However, these resins are nonpolar and have poor adhesion to many inorganic substrates, such as metals, metal oxides, chromate layers, ceramics, and plastics.

The coupling agent composition of the present invention typically affords much improved adhesion between inorganic substrates and benzocyclobutene-based resins. Because adhesion is maintained after exposure to conditions of high temperature and humidity, the coupling agent provides superior performance over other adhesion promoters known in the art. Other benefits of the coupling agent composition are that, unlike some other silanes, no acid catalysis or acetoxy leaving groups are required. Such silanes or preparatory methods result in a small amount of acid left on the substrate after application of the silane, and thus require an additional solvent rinse and drying step, which is not required with this coupling agent composition.

The coupling agent comprises a mixture of a vinylsilane and an aminosilane. The vinylsilane can be generally represented by the formula
(R₁)ₐSi(R₂)_{b}(X)_{4-a-b}
where each R₁ is independently an alkenyl or alkynyl group having no more than 3 covalent bonds separating the carbon-carbon double or triple bond and the silicon (Si) atom. Examples of R₁ include vinyl, allyl, 1-butenyl, 2-butenyl, 3-butenyl, 2-methyl(3-butenyl), and the like, with vinyl being preferred. Each R₂ is independently an alkyl or aryl group having from 1 to about 8 carbons. Each X is independently an alkoxy group having from 1 to about 8 carbon atoms with methoxy and ethoxy being preferred, and a is 1, 2, or 3, preferably 1, and b is 0, 1, or 2, preferably 0, and a+b is greater than or equal to 1 and less than or equal to 3. Examples of suitable vinylsilanes include vinyltriethoxysilane, allyltriethoxysilane, 3-butenyltriethoxysilane (BTES), and their mixtures. In at least one embodiment, the vinylsilane is vinyltriethoxysilane (VTES). Any aminosilane is suitable for use in the present invention. In some embodiments, the aminosilane can be generally represented by the formula
(Y)ₐSi(R₂)_{b}(X)_{4-a-b}
where each Y is independently an aminoalkyl group HN(R)R₃— or an aminoaryl group HN(R)Ar—, where R is either a hydrogen (H) or an alkyl group, R₃ is an alkyl or alkyl amino alkyl or alkyloxy alkyl radical containing from 2 to about 10 carbon atoms, and Ar is an aryl radical. Examples of Y include 3-aminopropyl, 4-aminobutyl, N-(2-aminoethyl)-3-aminopropyl (NH₂CH₂CH₂NHCH₂CH₂CH₂—), N-methyl-3-aminopropyl, aminophenyl, and the like, with 3-aminopropyl being preferred. Each R₂ is independently an alkyl or aryl group having from 1 to about 8 carbons. Each X is independently an alkoxy group having from 1 to about 8 carbon atoms with methoxy and ethoxy being preferred, and a is 1, 2, or 3, preferably 1, and b is 0, 1, or 2, preferably 0, and a+b is greater than or equal to 1 and less than or equal to 3. Examples of suitable aminosilanes include 3-aminopropyltriethoxysilane, N-methyl-3-aminopropyltrimethoxysilane, 4-aminobutyltriethoxysilane, N-(2-aminoethyl)-3-aminopropyltrimethoxysilane, aminophenyltrimethoxysilane, and their mixtures. In at least one embodiment, the aminosilane is 3-aminopropyltriethoxysilane (APS).

The coupling agent may comprise a mixture of VTES and APS. In at least one embodiment, the relative weight percent of APS based on the total weight of APS and VTES is greater than 0; in some embodiments it is greater than 10. In at least one embodiment, the relative weight percent of APS based on the total weight of APS and VTES is less than 70 and in another embodiment it is less than 50. In at least one embodiment the relative weight percent of the APS is about 20 and the relative weight percent of the VTES is about 80. In at least one embodiment, the relative weight percent of APS based on the total weight of APS and VTES is greater than 0 and less than 70, and in another embodiment it is greater than 0 and less than 50, and in another embodiment it is greater than 10 and less than 50.

The ethoxy groups in VTES and APS may be partially or fully replaced with other groups that are leaving groups upon hydrolysis, such as other alkoxy groups, for example methoxy. Also, the ethoxy groups may be partially replaced with non-leaving groups, such as alkyl groups, for example methyl, but the vinylsilane and aminosilane preferably contain at least one leaving group reactive in hydrolysis.

The coupling agent may comprise a mixture of a vinylsilane and an aminosilane wherein the relative mole percent of the aminosilane based on the total moles of aminosilane and vinylsilane in at least one embodiment is greater than 0 and in another embodiment it is greater than 8.7. In at least one embodiment the relative mole percent of the aminosilane based on the total moles of aminosilane and vinylsilane is less than 66.7 and in another embodiment it is less than 46.2. In at least one embodiment, the relative mole percent of the aminosilane based on the total moles of aminosilane and vinylsilane is greater than 0 and less than 66.7, and in another embodiment it is greater than 0 and less than 46.2.

The silane mixture can be partially or fully hydrolyzed. The amount of water used in the hydrolysis reaction depends upon a variety of factors including the degree of hydrolysis desired. To achieve complete hydrolysis, a stoichiometric amount of water to completely hydrolyze the silane is 1 molar equivalent of water for each molar equivalent of alkoxy group present on the silane. In practice, less than a stoichiometric amount of water is required for complete hydrolysis since water is formed by condensation reactions during the hydrolysis. Preferably, the water is purified, for example by deionization or distillation.

The coupling agent or coupling agent components may be dissolved in a solvent and applied to the substrate. Suitable solvents include organic solvents and water or a mixture of the two. Preferable solvents are alcohols, water, and their mixtures. The silane coupling agent may be formed on the substrate by applying a solution including the vinylsilane, aminosilane and their hydrolysis and condensation products.

Benzocyclobutenes are arylcyclobutenes in which the aromatic moiety is benzene. U.S. patents which report exemplary benzocyclobutene (BCB) resins include U.S. Pat. Nos. 4,687,823; 4,730,030; 4,759,874; 4,783,514; 4,812,588; 4,826,997; 4,973,636; and 5,025,080. Suitable BCB resins are commercially available from Dow Chemical under the trade name CYCLOTENE and are based on divinylsiloxane bis-benzocyclobutene and its prepolymerized or b-staged form. BCB polymers have excellent dielectric properties, both dielectric constant and loss are low, well into the upper frequency range (1-40 GHz), even in high humidity operating conditions. Other suitable BCB-based resins include toughened BCB-based resins, such as those described in co-pending U.S. published patent application 2004-0256731 A1 and U.S. Pat. No. 6,420,093. As described in U.S. Pat. No. 6,420,093, BCB may be toughened by adding polybutadiene. In at least one embodiment, the polybutadiene has (meth)acrylate end groups.

The BCB-based resin may contain fillers. Examples of suitable fillers include, but are not limited to, silica (SiO₂), alumina, quartz, and glass. These fillers are often added to lower the overall coefficient of thermal expansion (CTE) of the dielectric composite material. In some cases the fillers provide for increased heat or electrical conductivity. Suitable amounts of these additives for at least one embodiment of the present invention are from about 50 to about 75 wt. % based on the total weight of the resin with filler.

Other additives may be used in the BCB-based resin. Useful additives include antioxidants, stabilizers, dyes, colorants, and the like. Suitable amounts of these additives for at least one embodiment of the present invention are from about 0.01 to about 10 wt. % based on the total weight of the resin with additives.

The BCB resin may be partially or fully cured after it is applied on the coupling layer. The BCB is typically cured by exposure to heat or UV radiation. The metal layer with the partially or fully cured BCB is suitable for use in, for example, a multi-layer structure. Exemplary multi-layer structures and devices are described in co-pending published U.S. Patent App. 2004/0256731.

The coupling agent of the present invention may be suitable for use with substrates and electronic packages that include one or more inorganic layers adjacent to one or more BCB-based resin dielectric layers. Representative inorganic substrate materials often used in electronics applications such as multichip modules, flat panel displays, integrated circuits, and the like, which can be coated with the BCB-based coating composition include metals such as aluminum, copper, titanium and chrome; ceramics such as alumina, silica, MgO, BeO, including spinels, aluminum nitride, boron nitride, silicon nitride, gallium arsenide; and glasses such as fiber glass, lime glass, flint glass, borosilicate glass, and those available under the trade names PYREX and VYCO; and substrates commonly used in high density electronic circuitry, such as silicon, thermally oxidized silicon, GaAs, alumina and aluminum, which are commonly treated by processes such as oxygen plasma etching or RCA cleaning, to control surface chemistry.

The inorganic layer may be a conductive layer made of any suitable type of conductive material. Examples of suitable conductive materials included laminated low profile copper foil, plated copper, and sputtered aluminum. The conductive layer is typically less than about 40 μm thick, more typically 12 μm. Copper foil substrates are preferably thin, typically 5 μm or less of electrodeposited copper with low profile surfaces. Copper foil this thin is a fragile material and must be mechanically supported on a carrier foil. The carrier foil is typically copper or aluminum and 30 to 40 μm thick. Copper foil manufacturers supply the thin copper foils on the carrier foils. In this form the thin copper foil can be coated with primers such as the silane coupling agents of this invention and then coated with or laminated to dielectric layers. The dielectric layer can be used to bond the coated copper foil to an article or substrate. The carrier foil can be removed by simply peeling it away from the thin copper foil. The dielectric layer and article or substrate to which it is bound then provides the mechanical support for the thin copper. Depending on the nature of the dielectric material, it may have to be cured prior to the removal of the carrier foil to provide sufficient mechanical support. The thin copper foil may subsequently undergo further processing, such as, plating with additional copper to increase its thickness and patterning by known photolithographic and chemical etching techniques to provide a patterned electrical conductor.

Prior to deposition of the coupling agent, the conductive layer may be surface treated. This may be done to prevent copper migration, impart oxidation resistance, impart corrosion resistance, or to passivate. Suitable surface treatment methods include, but are not limited to, deposition of an extremely thin layer made substantially of zinc or a zinc alloy formed by co-depositing zinc with copper, nickel, tin and/or cobalt. A chromate treatment of the conductive layer or in the case where a thin layer of zinc or zinc alloy is already deposited on the conductive layer, a chromate treatment of the zinc or zinc alloy on the conductive layer may be carried out to form an extremely thin, chromate layer. In the case of thin, electrodeposited copper foils, the copper foil manufacturer often provides the thin copper foil on a carrier foil with the above-mentioned surface treatments applied to the exposed side of the thin copper foil.

### EXAMPLES

This invention is illustrated by the following examples, but the particular materials and amounts thereof recited in these examples, as well as other conditions and details should not be construed to unduly limit this invention. Silane Materials Used:

1) Isocyanurate—tris(3-trimethoxysilylpropyl)isocyanurate (Gelest, Inc. Tullytown, Pa.)

2) MPS—3-mercaptopropyltrimethoxysilane (Gelest, Inc.)

3) Octenyl—7-octenyltrimethoxysilane (Gelest, Inc.)

4) Styryl—styrylethyltrimethoxysilane (Gelest, Inc.)

5) Urethane—O-(propargyloxy)-N-(triethoxysilylpropyl)urethane (Gelest, Inc.)

6) VTAS—vinyltriacetoxysilane (or triacetoxyvinylsilane, Aldrich, Milwaukee, Wis.)

7) VTES—vinyltriethoxysilane (or triethoxyvinylsilane, Aldrich)

8) BTES—butenyltriethoxysilane (mixed butenyl isomers, mainly 3-butenyl, Gelest, Inc.)

9) ETES—ethyltriethoxysilane (Aldrich)

10) APS—3-aminopropyltriethoxysilane (Aldrich)

### Example Set 1

### Comparative Examples 1 to 4 and Examples 5 to 7

These examples and comparative examples are various silanes and silane mixtures that were evaluated as coupling agents. Each of the silanes has at least one chemical moiety believed to be reactive or compatible with BCB resin and/or copper foil.

The following method was used to make each silane solution samples: The silane composition was added to a glass vial, then 95% ethanol (95 wt % ethanol (EtOH)/5 wt % deionized water) was added to make a 3 wt % total silane(s) solution, except for Comparative Example 3 in which 100 wt % deionized water was used instead of the 95% ethanol. The vial was capped and shaken vigorously for a minute or two. The silane solution was allowed to sit for the period of time indicated in Table I to allow for partial or full hydrolysis. Then the silane solution was applied to a 16.5 cm×20.3 cm (6.5 in×8 in) piece of copper foil available from Metfoils AB (Perstorp, Sweden). The Metfoils copper foil was approximately 5 micron thick, electrodeposited, low profile Cu on a 30 micron Al carrier. The Cu foil was passivated on the exposed side by an extremely thin, substantially zinc barrier layer and a chromate layer applied by the manufacturer. The silane solution was applied by holding the foil in a vertical position and applying the silane solution to the passivated Cu side by pipette and allowing excess solution to run off. The Metfoils copper foil was immediately blown dry with nitrogen, then the silane-treated copper foil was baked in an air convection oven at 140° C. for 15 min.

36 micron thick copper foil available under the trade name COPPERBOND from Olin Corp. (Norwalk, Conn.) was then coated on one side with a mixture of toughened benzocyclobutene (BCB) and silica in toluene/mesitylene (approximately 78 wt. % toluene) solvent. After drying to remove the solvents, the BCB-based resin coating was 36 microns thick.

The BCB-based resin was made of 70 wt % of a silica filler (SO-E2 from Tatsumori, Ltd., Tokyo, Japan) and 30 wt % of toughened BCB. The toughened BCB contained a divinyl siloxane bis-benzocyclobutene that had been partially reacted or pre-polymerized and a polybutadiene-based toughener. The toughened BCB is available under the trade name CYCLOTENE from Dow Chemical. The BCB/toughener ratio of the toughened BCB was 85/15 w/w. Additional information regarding the BCB-based resin can be found in U.S. Patent App 2004-0256731.

The silane-treated Metfoils copper foil was then laminated to the BCB-coated COPPERBOND Cu foil at 235° C. and 5.62 MPa (800 psi) for 2 hours in a Carver Press (with no vacuum). The lamination also served to cure the BCB-based resin.

After the 2 hours of heating, the laminate was allowed to cool under pressure for approximately 1.5 hours (to approximately 125-150° C.). The laminate was then removed from the press and allowed to cool to room temperature. Four to five 1 in (2.54 cm) wide strips were cut from the laminate. The strips were cut crossweb to the coating direction of the BCB-based resin.

Subsequently, 90 degree peel tests were performed on the strips using an INSTRON tester at a crosshead speed of 2 in/min (5.08 cm/min). The resin-coated COPPERBOND side of the laminate was fixed to a rotating wheel jig. One end of the silane-treated Metfoils copper foil was placed in the INSTRON tester grip and pulled at 2 in/min (5.08 cm/min). This geometry resulted in failure at or very close to the silane-treated Metfoils copper foil/BCB-based resin interface. The results are given in Table I below:

TABLE I
Peel Strength of silane-treated Metfoils Cu Foil laminated to BCB-based
resin-coated Olin COPPERBOND Cu. Testing silane-treated
Metfoils/BCB-based resin interface.

| | | | | | | Time Between Silane |
|---|---|---|---|---|---|---|
| | | Mean Peel | | | | Solution Prep & |
| | Composition | Strength | | Std. Dev. | | Application to Cu |
| Ex. | [w/w] | [lb/in] | [N/cm] | [lb/in] | [N/cm] | (Metfoil) |
| C1 | No Silane | 0.54 | 0.95 | 0.06 | 0.11 | NA |
| C2 | 100 APS | 1.03 | 1.80 | 0.09 | 0.16 | 1 day |
| C3 | 100 APS in DI | 0.69 | 1.21 | 0.09 | 0.16 | 1 day |
| | (H₂O) | | | | | |
| C4 | 100 VTES | 0.82 | 1.44 | 0.09 | 0.16 | 1 day |
| 5 | 80 VTES/20APS | 4.37 | 7.65 | 0.25 | 0.44 | 1 day |
| 6 | 80 VTES/20APS | 4.01 | 7.02 | 0.13 | 0.23 | 7 days |
| 7 | 80 BTES/20 | 2.83 | 4.96 | 0.15 | 0.26 | 2 days |
| | APS | | | | | |

As Table I shows, the silane compositions having a mixture of a vinylsilane and an aminosilane have a higher mean peel strength than compositions with the individual silane components. In particular, the silane mixture of 80 wt % VTES/20 wt % APS coupling agent affords excellent performance.

### Example Set 2

### Comparative Examples 8 to 11 and Examples 12-14

Comparative Examples C8 to C11 used the same materials prepared above for Comparative Examples C1, C2, C3, C4(C14), respectively, and Examples 12-14 used the same materials prepared above for examples 5(15), 6(16), and 7(25), respectively. Portions of the laminates not used for the previous examples were cut into ¼ in. wide strips and the strips placed in a pressure cooker, where they were exposed to 121° C. and 100% RH (Relative Humidity) for 96 hours. Afterwards, 90 degree peel tests were performed on the strips, in the same manner as described above, to determine the peel strength between the silane treated Metfoils copper foil and the BCB-based resin. Table II shows the peel strengths before and after conditioning in the pressure cooker, and the percent change in peel strength.

TABLE II
Peel Strengths of Silane-treated Metfoils to BCB-based Resin Before
and After Pressure Cooker (PC)*†

| | | Mean Peel | | Mean Peel | | |
|---|---|---|---|---|---|---|
| | | Strength | | Strength | | |
| | Composition | Before PC | | After PC | | % |
| Ex. | [w/w] | [lb/in] | [N/cm] | [lb/in] | [N/cm] | Change |
| C8 | No Silane | 0.54 | 0.95 | 0.13 | 0.23 | −76 |
| C9 | 100 APS | 1.03 | 1.80 | 0.36 | 0.63 | −65 |
| C10 | 100 APS in DI | 0.69 | 1.21 | 0.31 | 0.54 | −55 |
| | H₂O | | | | | |
| C11 | 100 VTES | 0.82 | 1.44 | 0.17 | 0.30 | −79 |
| 12 | 80 VTES/20 | 4.37 | 7.65 | 4.67 | 8.18 | +7 |
| | APS | | | | | |
| 13 | 80 VTES/20 | 4.01 | 7.02 | 4.00 | 7.01 | 0 |
| | APS | | | | | |
| 14 | 80 BTES/20 | 2.83 | 4.96 | 2.03 | 3.56 | −28 |
| | APS | | | | | |

*Silane solutions were applied to each Metfoils copper foil 1 day after their preparation, except for Example 14 which was applied 2 days later and Example 13 which was applied 7 days after its preparation.
†The peel strengths before PC were obtained on 1 in. wide strips while peel strengths after PC were obtained on ¼ in. wide strips. The ¼ in. wide strips are a more sensitive indicator of the ability of the system to maintain adhesion in the presence of high heat and humidity.

As Table II shows, the silane compositions having a mixture of a vinylsilane and an aminosilane have a higher mean peel strength than compositions with the individual silane components both before and after exposure to a pressure cooker. In particular, the silane mixture of 80 wt % VTES/20 wt % APS coupling agent affords excellent performance with no loss in adhesion seen after exposure to very high humidity. Therefore, this coupling agent provides very high peel strength for BCB-based resin to copper foils under normal environmental conditions and is able to maintain this high adhesion when subjected to very demanding conditions.

### Example Set 3

### Examples 15-24

These examples show compositional ranges of VTES to APS on two types of copper foils: one is the copper foil described above in the first set of examples and available from Metfoils, and the other is available under the tradename MICROTHIN from Oak Mitsui (Hoosick Falls, N.Y.). The Oak Mitsui MICROTHIN was about 3 to 5 microns thick, electrodeposited, low profile Cu on an approximately 35 microns thick, electrodeposited Cu carrier foil. The 3 to 5 microns thick copper foil was protected against corrosion, copper migration and passivated on the exposed side by deposition of extremely thin layers made substantially of Ni, Zn, and a chromate layer all applied by the manufacturer.

Preparation of the silane solutions, application to the copper foils, and subsequent lamination to the BCB-based resin-coated copper foil was as described above for Example Set 1. The time between silane solution preparation and its application to the copper was 1 day for the Oak Mitsui MICROTHIN copper and 2 days for the Metfoils copper. In the case of the MICROTHIN copper foil, after the laminates were formed, the carrier copper layer was removed and the remaining 3 to 5 microns thick MICROTHIN copper foil was plated up with copper to a total thickness of approximately 20 microns.

90 degree peel tests, as described above, were performed a few days later. The peel strengths for Examples 15-19 (using METFOILS copper foils) and Examples 20-24 (using MICROTHIN copper foils) are given in Table IIIA and IIIB, respectively. The samples were also cut into ¼ in wide strips and conditioned in the pressure cooker under the same conditions as described above for Example Set 2. The peel strengths after such conditioning and the percent change in the peel strengths are also provided in the tables.

TABLE IIIA
Peel Strengths of VTES/APS-treated Metfoils Cu Foil to BCB-based
Resin Before and After Pressure Cooker (PC).

| | | Mean Peel | | Mean Peel | | |
|---|---|---|---|---|---|---|
| | Composition | Strength | | Strength | | |
| | VTES/APS | Before PC | | After PC | | |
| Ex. | [w/w] | [lb/in] | [N/cm] | [lb/in] | [N/cm] | % Change |
| 15 | 96/4 | 4.02 | 7.05 | 3.96 | 6.94 | −1 |
| 16 | 90/10 | 4.20 | 7.36 | 4.21 | 7.37 | 0 |
| 17 | 80/20 | 4.28 | 7.50 | 4.58 | 8.02 | +7 |
| 18 | 70/30 | 4.26 | 7.46 | 4.30 | 7.53 | +1 |
| 19 | 50/50 | 3.99 | 6.99 | 3.86 | 6.76 | −3 |

TABLE IIIB
Peel Strengths of VTES/APS-treated Oak Mitsui Microthin Cu Foil to
BCB-based Resin Before and After Pressure Cooker (PC).

| | | Mean Peel | | Mean Peel | | |
|---|---|---|---|---|---|---|
| | Composition | Strength | | Strength | | |
| | VTES/APS | Before PC | | After PC | | |
| Ex. | [w/w] | [lb/in] | [N/cm] | [lb/in] | [N/cm] | % Change |
| 20 | 96/4 | 2.28 | 3.99 | 1.89 | 3.31 | −17 |
| 21 | 90/10 | 2.70 | 4.73 | 2.83 | 4.96 | +5 |
| 22 | 80/20 | 2.85 | 4.99 | — | — | — |
| 23 | 70/30 | 2.91 | 5.10 | — | — | — |
| 24 | 50/50 | 2.77 | 4.85 | 1.47 | 2.57 | −47 |

### Example Set 4

### Examples 25-28

In these examples a BCB-based resin of the same composition as in Example Set 1 was solvent-coated onto primed copper foils in contrast to the previous examples in which 100 wt. % solids BCB-based resin was laminated onto primed copper foils. Samples were prepared by first priming pieces of MICROTHIN copper foil with coupling agents of varying VTES/APS compositions, made as described in Example Set 1. The time between silane solution preparation and its application to the copper was 1 day. The BCB-based resin was solvent coated onto the primed foil by knife coating by hand. The coating dispersion was approximately 54 wt % solids in a toluene/mesitylene solvent system. The solvent was approximately 78 wt. % toluene. Additional information regarding the BCB-based resin can be found in U.S. Patent App 2004-0256731. The samples were then allowed to air dry at room temperature for 15 minutes, then placed in an air convection oven at 100° C. for 15 minutes, and then another air convection oven at 140° C. for 20 minutes to remove the solvent. The dried BCB-based resin coating was about 36 microns thick. These resin-coated copper foils were then laminated to Metfoils copper foil that had been previously primed with VTAS. Lamination was at 235° C. and 5.62 MPa (800 psi) for 2 hours. The carrier copper layer of the MICROTHIN copper foils was removed and the remaining 3 to 5 microns thick copper layer plated up to 20 microns.

90 degree peel tests were conducted as described in Example Set 1 with the end of the silane-treated MICROTHIN copper foil being placed in the Instron grip and pulled. Strips were also conditioned in a pressure cooker as described in Example Set 2 and then peel tested. The results are given below in Table IV.

TABLE IV
Peel Strengths of VTES/APS-treated Oak Mitsui Microthin Cu Foil to
BCB-based Resin that was Solvent-Coated onto the Oak Mitsui
Microthin. Peel Strengths Before and After Pressure Cooker (PC).

| | | Mean Peel | | Mean Peel | | |
|---|---|---|---|---|---|---|
| | Composition | Strength | | Strength | | |
| | VTES/APS | Before PC | | After PC | | |
| Ex. | [w/w] | [lb/in] | [N/cm] | [lb/in] | [N/cm] | % Change |
| 25 | 90/10 | 1.23 | 2.15 | 1.49 | 2.61 | +21 |
| 26 | 80/20 | 1.69 | 2.96 | 1.89 | 3.30 | +12 |
| 27 | 50/50 | 1.90 | 3.33 | 1.40 | 2.45 | −26 |
| 28 | 30/70 | 1.89 | 3.15 | 1.01 | 1.77 | −47 |

### Example Set 5

### Comparative Example 29 and Example 30

In these examples, MICROTHIN copper foil was primed by coating silane solutions onto the foils and then dried and baked at temperatures in the range of about 100 to 150° C. under nitrogen using a pilot-scale solution coating line. The silane solutions were made in the same manner as described in Example Set 1. The time between silane solution preparation and its application to the copper was 1 day. The BCB-based resin was solvent coated onto the primed foil and dried under nitrogen using same line to give about a 36 microns thick BCB-based resin coating. Priming was done with two different coupling agents. 100% APS in deionized water was used for Comparative Example 29. 70/30 w/w VTES/APS in 95% EtOH was used for Example 30. The BCB-based resin-coated copper foils were then used to make laminates for peel testing. They were laminated to a rigid copper core (1 ounce electrodeposited Cu foil). The carrier copper of the MICROTHIN foil was peeled away, and the remaining 3 to 5 microns Cu layer was cleaned by microetching with persulfate or H₂SO₄/H₂O₂ solution, and then plated up to a total of 9 microns thick Cu. The Cu surface was then cleaned, and a dry film photoresist was laminated to the Cu surface. The photoresist was imaged and developed, and the exposed Cu etched away to form several ¼ in wide by 4 in long by 9 microns thick Cu strips running in parallel. The cross-linked photoresist was then stripped from the top of these Cu strips.

90 degree peel tests were performed before and after exposure to a pressure cooker. The pressure cooker conditions and test method are the same as described for Example Sets 1 and 2. The results are presented in Table V.

TABLE V
Peel Strengths of silane-treated Oak Mitsui Microthin Cu Foil to BCB-
based Resin that was Solvent-Coated onto the Oak Mitsui Microthin.

| | | Mean Peel | | Mean Peel | | |
|---|---|---|---|---|---|---|
| | | Strength | | Strength | | |
| | Composition | Before PC | | After PC | | |
| Ex. | [w/w] | [lb/in] | [N/cm] | [lb/in] | [N/cm] | % Change |
| C29 | 100 APS in DI | 1.70 | 2.98 | 0.50 | 0.88 | −71 |
| | H₂O | | | | | |
| 30 | 70 VTES/ | 1.73 | 3.03 | 1.90 | 3.33 | +10 |
| | 30 APS | | | | | |
| | in 95% EtOH | | | | | |

### Example Set 6

### Comparative Examples C31-C48

These comparative examples were made in a manner similar to those of Example Set 1. 90 degree peel tests were conducted as described in Example Set 1. The results are given below in Table VI.

TABLE VI
Peel Strength of silane-treated Metfoils Cu Foil laminated to BCB-based resin-
coated Olin COPPERBOND Cu. Testing silane-treated Metfoils/BCB-based
resin interface.

| | | | | | | Time Between Silane |
|---|---|---|---|---|---|---|
| | | Mean Peel | | | | Solution Prep & |
| | Composition | Strength | | Std. Dev. | | Application to Cu |
| Ex. | [w/w] | [lb/in] | [N/cm] | [lb/in] | [N/cm] | (Metfoil) |
| C31 | 100 VTAS | 4.12 | 7.22 | 0.09 | 0.16 | 1 day |
| C32 | 100 Isocyanurate | 0.14 | 0.25 | 0.01 | 0.02 | 31 days |
| C33 | 100 MPS | 0.80 | 1.40 | 0.07 | 0.12 | 1 day |
| C34 | 97 MPS/3 APS | — | — | — | — | Not applied, |
| | | | | | | precipitate formed |
| | | | | | | within 3 days |
| C35 | 80 MPS/20 APS | 1.91 | 3.34 | 0.23 | 0.40 | 1 hour, precipitate |
| | | | | | | formed within 1 day |
| C36 | 100 Octenyl | 0.95 | 1.66 | 0.10 | 0.18 | 31 days |
| C37 | 80 Octenyl/ | 0.45 | 0.79 | 0.05 | 0.09 | 1 day |
| | 20APS | | | | | |
| C38 | 80 Octenyl/ | 0.91 | 1.59 | 0.08 | 0.14 | 1 day |
| | 20 Urethane | | | | | |
| C39 | 50 Octenyl/ | 0.63 | 1.10 | 0.03 | 0.05 | 1 day |
| | 20 VTES | | | | | |
| C40 | 40 Octenyl/ | 1.47 | 2.57 | 0.05 | 0.09 | 1 day |
| | 40 VTES/ | | | | | |
| | 20 APS | | | | | |
| C41 | 100 Styryl | 2.36 | 4.13 | 0.12 | 0.21 | 26 days |
| C42 | 98 Styryl/ | 1.93 | 3.38 | 0.23 | 0.40 | 1 day, precipitate |
| | 2 APS | | | | | formed within 4 days |
| C43 | 80 Styryl/ | 2.23 | 3.91 | 0.21 | 0.37 | 1 hour, precipitate |
| | 20 APS | | | | | formed within 1 day |
| C44 | 80 Styryl/ | 3.15 | 5.52 | 0.10 | 0.18 | 1 day |
| | 20 Urethane | | | | | |
| C45 | 33 Styryl/ | 2.38 | 4.17 | 0.20 | 0.35 | 1 day |
| | 67 Urethane | | | | | |
| C46 | 100 Urethane | 1.52 | 2.66 | 0.09 | 0.16 | 26 days |
| C47 | 80 Urethane/ | 2.63 | 4.61 | 0.24 | 0.42 | 1 day |
| | 20APS | | | | | |
| C48 | 80 ETES/ | 2.17 | 3.80 | 0.35 | 0.61 | 1 day |
| | 20 APS | | | | | |

Various modifications and alterations of this invention will become apparent to those skilled in the art without departing from the scope and spirit of this invention and it should be understood that this invention is not to be unduly limited to the illustrative embodiments set forth herein.

What is claimed is:

1. An article comprising:
an inorganic surface,
a silane coupling agent layer on the inorganic surface, the silane coupling agent layer formed from a mixture comprising a vinylsilane and an aminosilane, and
a benzocyclobutene-based resin on the silane coupling agent layer, wherein the vinylsilane has the following formula:
(R₁)ₐSi(R₂)_{b}(X)_{4-a-b}
where each R₁ is independently an alkenyl or alkynyl group having no more than 3 covalent bonds separating the carbon-carbon double or triple bond and the silicon atom; each R₂ is independently an alkyl or aryl group having from 1 to about 8 carbons; each X is independently an alkoxy group having from 1 to about 8 carbon atoms; a is 1, 2, or 3; b is 0, 1, or 2; and a+b is greater than or equal to 1 and less than or equal to 3.

2. The article of claim 1 wherein R₁ is selected from the group consisting of vinyl, allyl, and butenyl.

3. The article of claim 1 wherein X is one of methoxy or ethoxy.

4. The article of claim 1 wherein the vinylsilane is selected from the group consisting of vinyltriethoxysilane, vinyltrimethoxysilane, allyltriethoxysilane, allyltrimethoxysilane, butenyltriethoxysilane, butenyltrimethoxysilane, and their mixtures.

5. The article of claim 1 wherein the aminosilane is represented by the following formula:
(Y)ₐSi(R₂)_{b}(X)_{4-a-b}
where each Y is independently an aminoalkyl group HN(R)R₃— or an aminoaryl group HN(R)Ar—, where R is either a hydrogen (H) or an alkyl group, R₃ is an alkyl or alkyl amino alkyl or alkyloxy alkyl radical containing from 2 to about 10 carbon atoms, and Ar is an aryl radical.

6. The article of claim 1 wherein the aminosilane is selected from the group consisting of 3-aminopropyltriethoxysilane, 3-aminopropyltrimethoxysilane, N-methyl-3-aminopropyltrimethoxysilane, 4-aminobutyltriethoxysilane, N-(2-aminoethyl)-3-aminopropyltrimethoxysilane, and their mixtures.

7. The article of claim 1 wherein the vinylsilane is vinyltriethoxysilane and the aminosilane is 3-aminopropyltriethoxysilane.

8. The article of claim 1 wherein the relative mole percent of the aminosilane based on the total moles of aminosilane and vinylsilane is greater than 0 and less than about 66.7.

9. The article of claim 1 wherein the relative mole percent of the aminosilane based on the total moles of aminosilane and vinylsilane is greater than 8.7 and less than about 46.2.

10. The article of claim 1 wherein the silane mixture comprises about 80 weight % vinyltriethoxysilane and about 20 weight % 3-aminopropyltriethoxysilane based on the total weight of the silanes.

11. The article of claim 1 wherein the silane coupling agent layer is formed on the inorganic layer by applying a solution including vinylsilane, aminosilane and their hydrolysis and condensation products followed by drying.

12. The article of claim 1 wherein the benzocyclobutene-based resin contains one or both of polybutadiene-based toughener and silica filler.

13. The article of claim 12 wherein the polybutadiene toughener has (meth)acrylate endgroup(s).

14. The article of claim 1 wherein the benzocyclobutene-based resin has been cured.

15. The article of claim 1 wherein the inorganic layer has been surface-treated.

16. The article of claim 1 wherein the inorganic layer is ceramic.

17. The article of claim 1 wherein the inorganic layer is metal.

18. The article of claim 17 wherein the metal layer has a chromate layer on its surface.

19. The article of claim 1 wherein the inorganic layer is copper.

20. The article of claim 19 wherein the copper layer has been surface-treated.

21. The article of claim 20 wherein the surface treatment comprises deposition of zinc or a zinc alloy containing one or more of copper, nickel, tin, and cobalt.

22. The article of claim 21 wherein the surface treatment further comprises formation of a chromate layer on the zinc or zinc alloy.

23. The article of claim 19 wherein the copper is in the form of copper foil.
